(19) United States
(12) Patent Application Publication
(10) Pub. No.: US 2011/0084814 A1
(43) Pub. Date: Apr. 14, 2011

(54) SECURITY TAG UTILIZING RFID REFLECTIVITY MODE POWER RATIONING

(75) Inventor: Karl Georg Ramsch, Schwetzingen (DE)

(73) Assignee: CHECKPOINT SYSTEMS, INC., Thorofare, NJ (US)

(21) Appl. No.: 12/900,100

(22) Filed: Oct. 7, 2010

Related U.S. Application Data
(60) Provisional application No. 61/249,843, filed on Oct. 8, 2009.

(51) Int. Cl. G06K 7/01

(52) U.S. Cl. 340/10.32; 340/10.1

(57) ABSTRACT

An RFID security tag which changes its reflectivity after receiving an interrogation signal is provided. The RFID security tag changes its reflectivity so that it becomes transparent to RF power of the RFID reader interrogation signal once the RFID security tag responds, thereby permitting surrounding RFID security tags to absorb the interrogation signal and to respond thereto. These surrounding RFID security tags then, in turn, change their reflectivity so that RFID security tags surrounding that second set of RFID security tags can absorb the interrogation signal and can also respond thereto. In this manner, a large plurality of RFID security tags, such as those associated with merchandise loaded on a palette, can be interrogated accurately.

### CROSS-REFERENCE TO RELATED APPLICATIONS

This utility application claims the benefit under 35 U.S.C. §119(e) of Provisional Application Ser. No. 61/249,843 filed on Oct. 8, 2009 entitled RFID REFLECTIVITY MODE POWER RATIONING and whose entire disclosure is incorporated by reference herein.

### BACKGROUND OF THE INVENTION

1. Field of the Invention

The present invention generally relates to the field of radio frequency identification (RFID) device communication protocols, and more particularly, to the management of power absorption and reflectivity of individual tags to facilitate reading of tags that are positioned close together and/or grouped in significant numbers.

2. Description of Related Art

RFID tags may be either backscatter or non-backscatter tags. Non-backscatter tags typically send information to readers by originating a carrier signal on which amplitude, frequency, or phase modulated data is impressed. Backscatter tags send information by modulating the reflectivity of the tag within a range that allows the tag to continue to be powered by the reader. Readers may detect such backscatter modulation a number ways, such as by sensing fluctuations in power of a resonant transmission antenna.

With respect to 13 MHz RFID operation, the term used to describe RFID tags or labels is the “load modulation” of the magnetic field. However, in the UHF RFID operation (e.g., 900 MHz), the pertinent term used is the “delta radar cross section” (dRCS) or backscatter which forms the signaling mechanism. As a result, the term “reflectivity” is expressed in terms of the RCS in meter². Thus, by way of example, the RCS of a ½ wavelength dipole in the 900 MHz range is approximately 0.01-0.02 m². The dRCS is approximately 10-0.1% change of the RCS.

Both backscatter and non-backscatter tags, especially those operating in the UHF or microwave ranges, are normally highly reflective whether or not they are actively communicating with a reader. If two tags are positioned along a line extending from the reader, the tag closer to the reader is fully illuminated by the reader. The tag further from the reader is not fully illuminated. Rather it is substantially occluded by the tag closer to the reader. Therefore the tag further from the reader receives less power than it would if the tag closer to the reader were absent.

This is particularly problematic when large numbers of tags are present. The tags closer to the reader can act as a mirror, reflecting signals back to a reader, and thus casting a shadow on the tags further from the reader. This may result in a failure to read the tags in the shadow.

In view of the foregoing, there still remains a need to allow security tags closest to a reader to respond to a reader's interrogation signal and then to become transparent or cloak itself to allow other security tags in the vicinity to respond.

### BRIEF SUMMARY OF THE INVENTION

A radio frequency identification (RFID) system is disclosed. The RFID system comprises: a reader for emitting an interrogation signal and for receiving response signals based thereon; and a first tag for emitting a respective response signal based upon receipt of the interrogation signal and defining a first reflectivity that casts a shadow on at least a second tag, wherein the first tag comprises circuitry that alters the first reflectivity state to a second reflectivity state that makes the first tag substantially transparent to the interrogation signal such that the interrogation signal can illuminate the second tag without physically moving either the first or second tag.

A method of interrogating a group of RFID tags is disclosed. The method comprises the steps of: (a) emitting a first reader signal from a reader toward the group of RFID tags; (b) energizing a first tag having an RFID chip and tuned to a reader frequency for defining a first reflectivity state of the first tag; (c) listening to instructions within the first reader signal by the first tag to determine if the first reader signal is an initial encounter or a repeat encounter; (d) generating a reflected response signal from the first RFID tag if the first reader signal is an initial encounter; (e) temporarily altering the reflectivity of the first RFID tag to a second reflectivity state to render the first RFID tag substantially transparent to the first reader signal, thereby permitting a second tag located in a shadow of first RFID tag to receive the first reader signal, and wherein the second tag is in a first reflectivity state for receiving the first reader signal; and (f) the second tag comprising an RFID chip and generating its own reflected signal from the first reader signal; and (g) the first tag restoring itself to the first reflectivity state after temporarily altering the reflectivity.

A radio frequency identification (RFID) tag is disclosed. The RFID tag comprises an antenna (e.g., a dipole antenna or a loop configuration), an RFID chip coupled to the antenna, wherein the RFID chip comprises tag reflectivity circuitry. The tag reflectivity circuitry permits the tag to become temporarily detuned from a first RFID reader signal emitted by an RFID reader once the RFID security tag has responded to the first RFID reader signal and then re-tunes the RFID tag to the RFID reader.

A method of automatically altering the reflectivity of an RFID tag is disclosed, The method comprises: (a) providing an antenna coupled to an RFID chip to form the RFID tag and wherein the RFID tag is initially tuned to an RFID reader frequency, defining a first reflectivity state; (b) energizing the RFID tag upon receipt of an RFID reader signal having a frequency to which the RFID tag is tuned; (c) listening, by the RFID chip, to instructions within the RFID reader signal by to determine if the reader signal is an initial encounter or a repeat encounter; (d) generating a reflected response signal from the RFID tag if the first reader signal is an initial encounter; (e) temporarily altering the reflectivity of the RFID tag to a second reflectivity state to render the RFID tag substantially transparent to the RFID reader signal; and (f) restoring the RFID tag to the first reflectivity state.

### BRIEF DESCRIPTION OF SEVERAL VIEWS OF THE DRAWINGS

The invention will be described in conjunction with the following drawings in which like reference numerals designate like elements and wherein:

FIG. 1A is a schematic view of a first embodiment of the security tag comprising a UHF or microwave RFID tag which includes two dipole antenna elements and an RFID chip that is adapted to dramatically alter the reflectivity of the tag;

FIG. 1B is a plan view of an enlarged exemplary implementation of the first embodiment shown in FIG. 1A;

FIG. 1C is a schematic view of a second embodiment of the security tag comprising a UHF or microwave RFID which also includes two dipole elements but wherein a pair of switches is utilized by the RFID chip to dramatically alter the reflectivity of the tag;

FIG. 2A is a schematic view of a third embodiment of the security tag comprising a low frequency (LF) or high frequency (HF) RFID tag which includes a loop antenna, an RFID chip that is adapted to dramatically alter the reflectivity of the tag, a first capacitor for tuning the tag to the operational frequency, and a second capacitor for altering the reflectivity of tag;

FIG. 2B is a schematic view of a fourth embodiment of the security tag also comprising an LF or an HF RFID tag which includes a loop antenna and an RFID chip that is adapted to dramatically alter the reflectivity of the tag;

FIG. 2C is an enlarged plan view of a fifth and most preferred embodiment of the present invention showing an RFID tag that includes a loop antenna and an RFID chip that is also adaptable to dramatically alter the reflectivity of the security tag;

FIG. 2D is a functional diagram depicting the first reflectivity state (“tuned”) of the exemplary fifth embodiment of the security tag; and

FIG. 2E is a functional diagram depicting the second reflectivity state (“detuned”) of the exemplary fifth embodiment of the security tag;

FIGS. 3A-3C together depict the operation of a system and method using the security tags of the present invention;

FIG. 4 is a flow diagram of the tag tuning/detuning process 600.

### DETAILED DESCRIPTION OF THE INVENTION

A way to address the problem of security tags reflecting the reader's interrogation signal away from surrounding security tags is to enable individual tags to conditionally alter their reflectivity dramatically. Such alteration may occur in response to a particular operational status, such as: the receipt of a certain signal or command from a reader; the completion of a transmission to the reader; or the sensing of an input or condition unrelated to the communications protocol with the reader or with other tags.

The alteration can be achieved by a number of means. For example, additional impedance could be introduced in parallel or in series with tag antenna elements. Alternatively, the antenna elements can be disconnected from either tuning elements of the tag or from the RFID integrated circuit (chip).

The alteration can be permanent but is preferably temporary. Temporary alteration can be achieved by an analog and/or digital timing circuit which controls the reflectivity alteration mechanism. A digital timing circuit, for example, may include a real-time clock circuit, e.g. a timer that holds the reflectivity altered for a specific number of seconds. An analog timing circuit can include a floating gate MOSFET switch (e.g., EPROM) wherein the floating gate has a useful decay period. Such can be achieved by adding a high impedance leakage path to a floating gate element that is otherwise completely isolated during non-programming periods.

Furthermore, the tuned range of the tag may be determined via the use of variable capacitors, as depicted in the figures of this application. It should be understood that the term “variable capacitors” is defined broadly. Dynamically variable capacitors may be achieved by any means but are preferably implemented on integrated circuit devices. For example, an n-bit variable capacitor could be implemented in a CMOS fabrication process using independent n-switches connected to n polysilicon to polysilicon, polysilicon to field, polysilicon to metal, or metal to metal plate capacitors with values of x, x/2, x/4 . . . x/n pF respectively. Other options include, but are not limited to, simple junction capacitors, voltage-controlled variable junction capacitors, MEMS devices, or even the use of active switched-capacitor methods. It is within the broadest scope of the invention to permit the signal processing unit (SPU, as discussed below) to configure the tag capacitances “on the fly”. The use of fixed capacitors is also within the broadest scope of the invention.

The invention of the present application results in an increased detection based on respective detection probability for a large tag population.

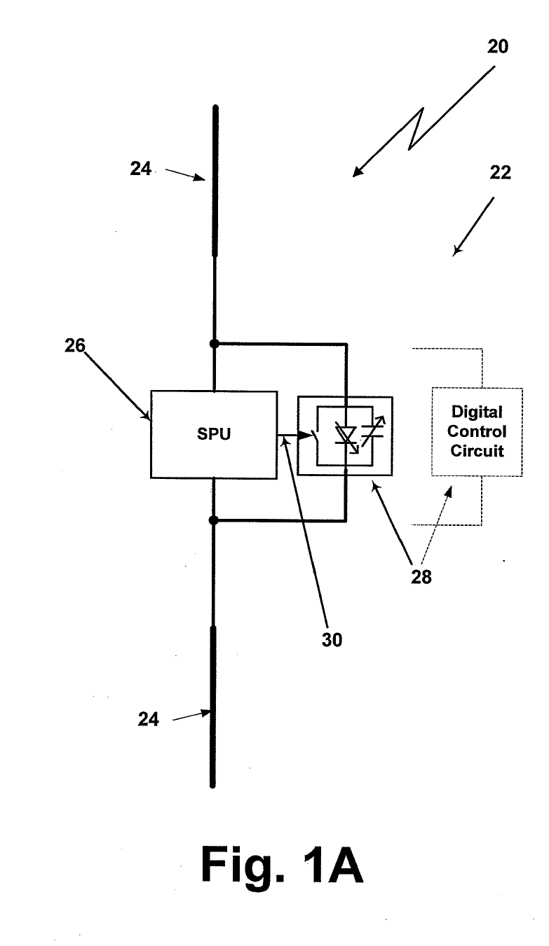

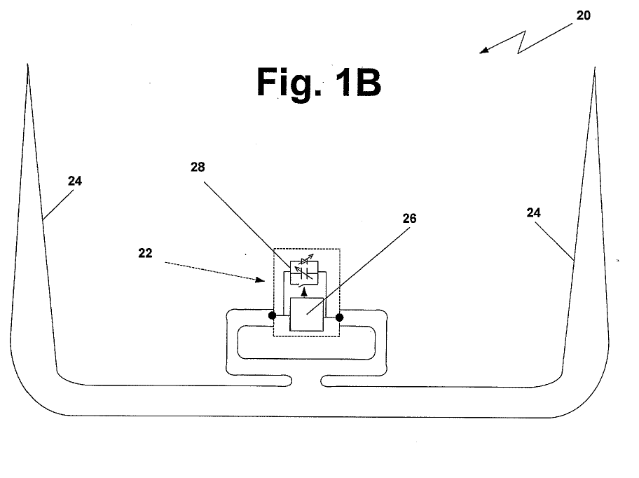

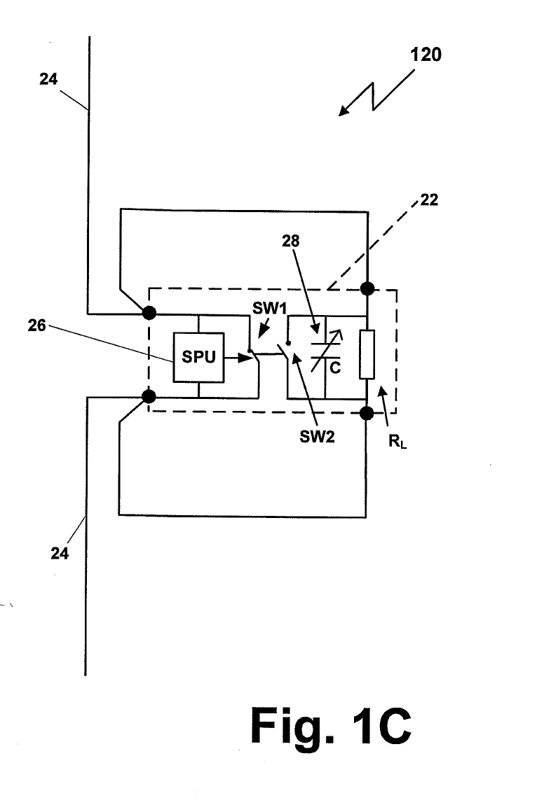

As shown in FIG. 1A, a preferred embodiment of the invention is a tag 20 which comprises two dipole antenna elements 24 and an RFID chip 22 that is adapted to dramatically alter the reflectivity of the tag. The chip contains a signal processing unit (SPU) 26 which may optionally contain any convenient RFID functions such as, but not limited to: power conditioning, rectification, and/or regulation circuitry; digital memory; program code stored in memory; a computer processor; a received data signal demodulator; and a transmitted response data modulator. By way of example only, a chip similar to the NXP G2iL series chips may serve as the RFID chip 22. In particular, the SPU 26 could be identical to the analogous portions of a NXP G2iL chip. However, preferably the RFID chip 22 is a “high Q” chip. Thus, for instance, such a chip operating in the UHF ranges approximately 860 MHz or 950 MHz would preferably present a stray capacitance at the antenna terminals of 1 pF or less, more preferably 0.7 pF or less, and most preferably approximately 0.5 pF or less.

The chip 22 also includes a variable impedance device 28. In FIG. 1A, the device 28 is depicted as being in parallel with the SPU 26, but it could optionally be positioned in series between dipole antenna element 24 and the SPU 26. The device 28 may comprise any circuitry useful to accomplishing the function of dramatic altering the reflectivity of the tag so as to allow more power from the reader to reach the other tags that are positioned further from the reader. In general, passive tags lack power pickup when they are present in a large tag population. Thus, by dramatically altering reflectivity of the tag this, in effect, reduces the extent to which the tag blocks reader signals by allowing more reader power to reach the other tags that are further from the reader. Preferably, the device 28 uses an analog and/or digital control circuit to effect the dramatic altering of the reflectivity of the tag for a limited period of time as described above. As shown in FIG. 1A, the variable impedance device 28 is preferably triggered by a control signal 30 from the SPU 26.

FIG. 1B depicts an actual implementation of an RFID UHF security tag using the variable impedance device 28 controlled by an SPU 26 all of which are electrically coupled to dipole antenna elements 24.

FIG. 1C depicts another embodiment of the RFID UHF security tag which can alter its impedance. In particular, this configuration uses a pair of switches that are controlled by the SPU 26 in opposition using the control signal 30. Therefore, when switch SW1 is closed, the variable impedance device 28 is shorted out and when switch SW1 is opened, switch SW2 is closed, thereby introducing the variable impedance device 28 into the antenna circuit.

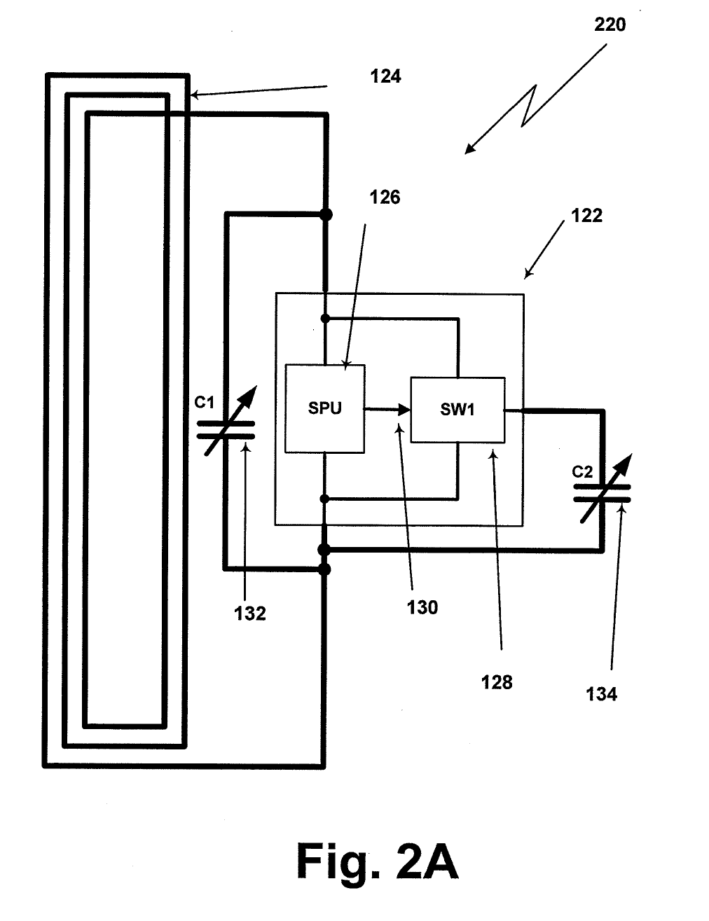

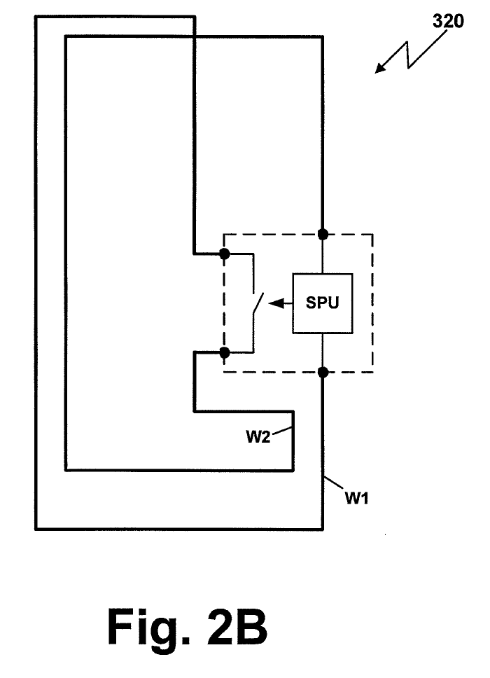

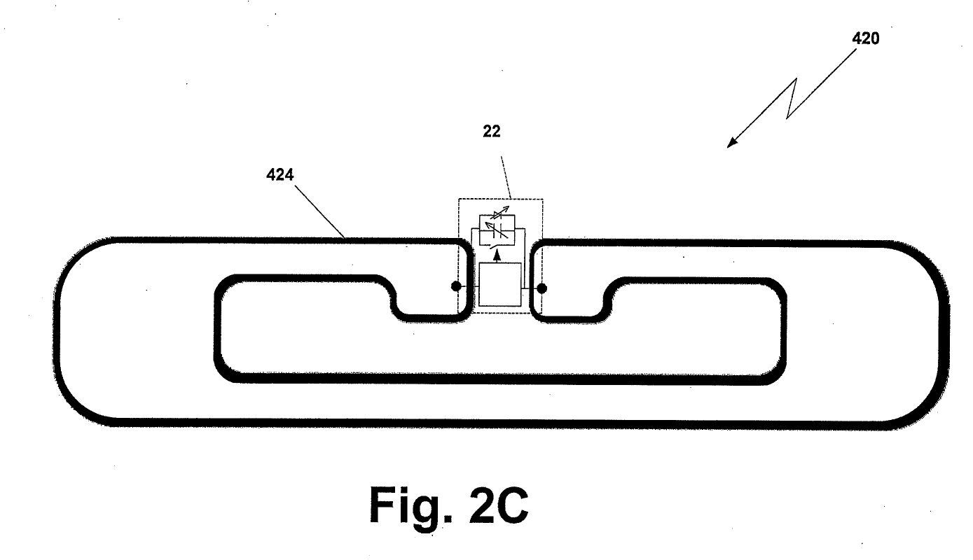

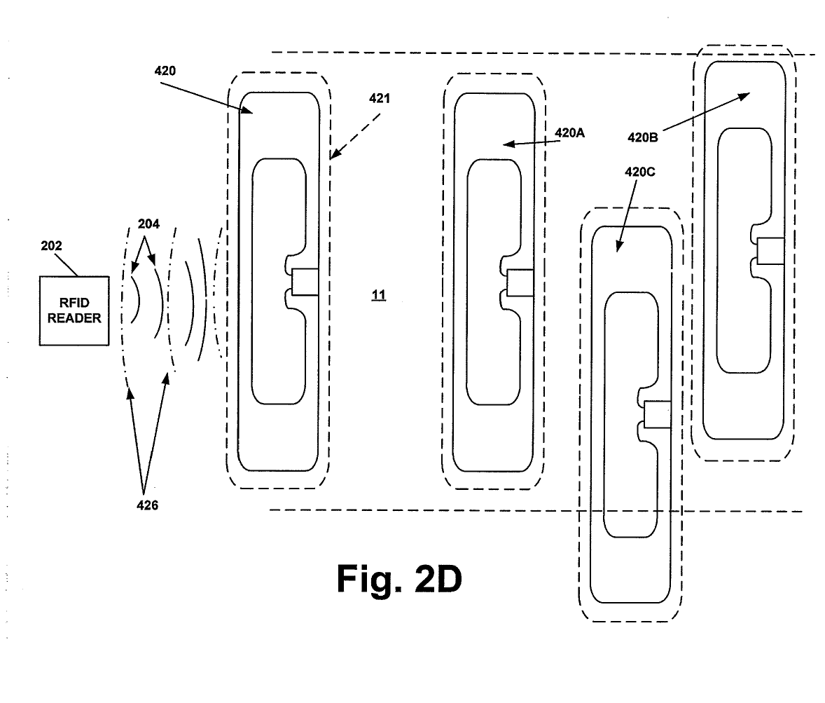

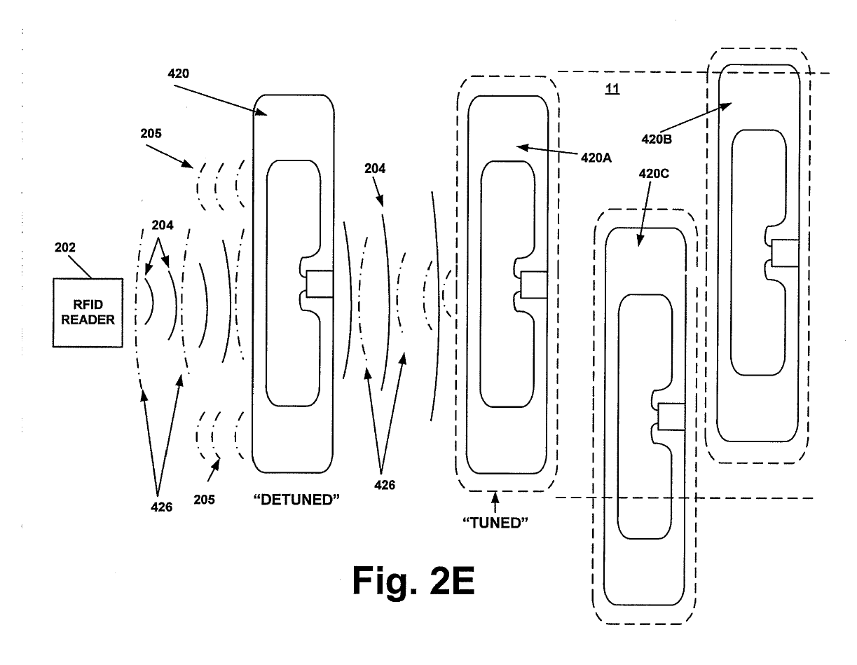

FIG. 2A illustrates some of the options for implementing embodiments of the invention. FIG. 2 shows a low frequency (LF) or high frequency (HF) RFID tag 120 which includes: a loop antenna 124; an RFID chip 122; a first variable capacitor (C1) 132 for tuning the tag to the operational frequency; and a second variable capacitor (C2) 134 for altering the reflectivity of tag. For example, to create an HF tag, C1 may be varied so that together C1 132, the loop antenna 124, and the chip 122 together form a resonant system with a peak response at 13.56 MHz for optimum performance using the ISO 15693 protocol. The SPU 126 of chip 122 is analogous the SPU 26 of chip 22, and control signal 130 performs the same function as control signal 30.

SW1 128 in FIG. 2A is somewhat different from the variable impedance devices 28 of FIGS. 1A-1C in that SW1 128 does not itself comprise the necessary impedance to effect the required alteration of reflectivity. Instead, SW1 128 switches the impedance of the second capacitor (C2) 134 into or out of connection with the resonant system (of loop antenna 124, C1 132, and chip 122) as prompted by control signal 130.

FIG. 2B depicts another variation wherein the security tag coil W1/W2 is open-circuited by the SPU 26 via the switch to remain temporarily non-reflective and then switch is closed to restore the tag's reflectivity. This configuration is most applicable in the low RF frequency regime (e.g., 13 MHz) rather than the UHF frequency bands since reflectivity of this tag is highly dependent upon current flow through the coil and the switch operates to permit current flow (i.e., when the switch is closed) or terminate current flow (i.e., when switch is open).

It should be noted that the switches may be implemented in a variety of ways, MEMs microswitches or solid state switches (JFETs, MOSFETs, etc.), etc. and any other type of switch known in the art.

FIG. 2C depicts a plan view of an enlarged plan view of a fifth embodiment 420 of the security tag of the present invention. As shown, the tag 420 comprises a loop 424 and an RFID chip 22 (as discussed previously with regard to the other embodiments). It should be understood that the RFID chip 22 shown is by way of example only and that any of the other RFID chip 22 configurations can be used. The preferred design is a single loop 424 which, by way of example only, may comprise dimensions 8 mm×50 mm or may be even be circular (e.g., 10 mm diameter such that the circumference is shorter than ⅓ wavelength in air at the applied RFID reader frequency).

By way of example only, the following discussion (and associated Table I) provides an explanation of the advantages of using temporary alteration of tag reflectivity based on the following scenario. The propagation of energy is in two dimensions through a set of tags with ideal half wavelength UHF dipole antennas, where the tags are arranged in rows and where the dipoles are aligned perpendicular to the direction of the propagation of the radio energy from a reader. It is assumed that all energy from the reader reaches the first row of tags. A fully resonant, tuned antenna ideally re-radiates 100% of the energy impinging upon it: 50% of the energy is reflected back toward to the reader antenna and 50% is radiated toward the next row of tags, and so on. Thus, each row will receive 50% of the energy impinging upon the prior row.

TABLE I
Propagation through Rows of Ideal Tuned Resonant Tags

| % of original energy | 1st | 2nd | 3rd | 4th |
|---|---|---|---|---|
| from the reader | Row | Row | Row | Row |
| % impinging on row | 100% | 50% | 25% | 12.50% |
| % reflected by the row back | 50% | 25% | 12.50% | 6.25% |
| to the reader | | | | |
| % re-radiated to the next row | 50% | 25% | 12.50% | 6.25% |
| further from the reader | | | | |
| % of energy from reader not | 0% | 0% | 0% | 0% |
| absorbed/re-radiated, and therefore | | | | |
| propagating to the next row | | | | |
| total energy reaching the next row | 50% | 25% | 12.50% | 6.25% |

This should now be compared to the detuned tag condition, i.e., the propagation in the same array of tags where the tag antennas are instead not tuned to the frequency of the reader. See Table II below. It is assumed that reflectivity therefore drops by 3 dB, i.e., 50%. (Simulations indicate that decreases of 3 to 4 dB in reflectivity may also be obtained in tags using, for instance, practical UHF loop antennas.) An interesting effect occurs with the detuned tags. As stated, the energy reflected back to the reader from the first row of tags drops by half, therefore to 25% of the original energy from the reader. Similarly, the amount of energy re-radiated to the next row also drops by half, to 25%. However, the remaining 50% of the original energy from the reader is not lost. It propagates uninterrupted to the second row of readers. The total energy reaching the second row is 75%, a 50% increase over the case where the tags in the row closet to the reader are tuned. The effect is more significant in rows further from the reader. For instance, the energy impinging the 4^{th} row is 400% higher than it is in the case where all the tags are tuned.

TABLE II
Propagation through rows of ideal detuned
resonant tags (with −3 dB reflectivity)

| % of original energy | 1st | 2nd | 3rd | 4^{th} |
|---|---|---|---|---|
| from the reader | Row | Row | Row | Row |
| % impinging on row | 100% | 75% | 56.25% | 42.19% |
| % reflected by the row back | 25% | 18.75% | 14.06% | 10.55% |
| to the reader | | | | |
| % re-radiated to the next row | 25% | 18.75% | 14.06% | 10.55% |
| further from the reader | | | | |
| % of energy from reader not | 50% | 37.5% | 28.13% | 21.09% |
| absorbed/re-radiated, and therefore | | | | |
| propagating to the next row | | | | |
| total energy reaching the next row | 75% | 56.25% | 42.19% | 31.64% |

In this much simplified illustration, it should be emphasized that non-ideal factors such as power consumption by the tags, multiple reflections between rows, phase effects, etc., have been neglected. Nonetheless, the principle of the advantage of selectively detuning a tag nearer the reader for purposes of enabling propagation of reader energy to a tag further from the reader along a pathway through the detuned tag is readily appreciated.

FIG. 2D depicts the first reflectivity state of the security tag 420 when the tag 420 is tuned to the frequency of the RFID reader 202. In particular, with the tag 420 “tuned,” the tag 420 forms an effective reflector, indicated by the dotted line 421 (also referred to as the radar cross section, RCS), of the incoming reader signal power 204 by generating a reflected signal 426. Thus, during this “tuned” state, a reduced reader signal power 204 is making its way past the security tag 420. However, as shown in FIG. 2E, once the tag 420 detunes itself (as also discussed previously with regard to the other embodiments), the tag 420 becomes substantially “transparent,” by permitting the incoming signal 204 to “pass through” the tag 420 and impinge on the tags 420A-420C located “in the shadow” 11 of the tag 420 (e.g., behind tag 420). The phrase “in the shadow of the tag” is meant to describe the relative position of at least two security tags where the presence of one tag effectively hides the other tag from receiving a reader signal 204. Thus, the only way to permit the other tag to receive the reader signal 204, other than physically displacing the tags, is to make the tag “creating the shadow” substantially transparent. It should be noted that there is some residual reflection 205 from the detuned tag 20 (FIG. 2E) due to the presence of the tag's metal loop 424 but the effect is that the overall tag 420 is rendered effectively transparent (hence the phrase “substantially transparent”).

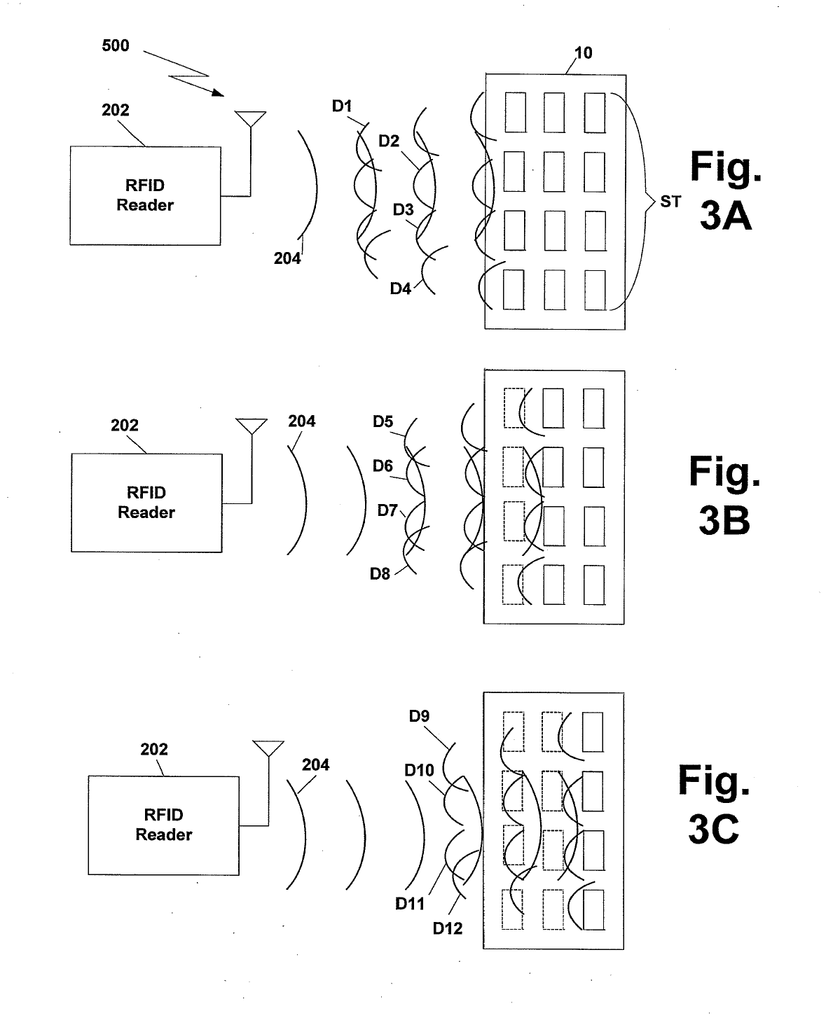

By way of example only, there is shown in FIGS. 3A-3C a system and method 500 for utilizing the security tags of the present invention therein. In particular, in FIG. 3A, there is shown an RFID reader 202 (e.g., 915 MHz) and a target box or pallet 10 containing a plurality of items each having a corresponding security tag ST of the present invention attached thereto. It should be noted that the security tags ST can be any of the security tags 20-420 discussed above. As shown in FIG. 3A, an interrogation signal 204 of the corresponding RF frequency is emitted by the RFID reader 202. When the first column of security tags ST absorbs a portion of the interrogation signal 204, each security tag ST emits its corresponding data D1-D4 back to the reader 202. In accordance with the RFID reflectivity operation discussed above, each security tag ST in the first column then changes its impedance to reflect a reduced portion of the interrogation signal 204; thus, the tag temporarily changes its reflectivity from a first reflectivity state to a second reflectivity state that makes the tag appear “substantially transparent” to the reader interrogation signal 204, which continues onto the next column, as shown in FIG. 3B. The second column of the security tags ST, then reflects a portion of the interrogation signal 204 and to form their corresponding signals D5-D8 back to the reader 204; these security tags ST in the second column then change their impedances to reflect a reduced portion of the interrogation signal 204. Next, the third column of security tags ST then reflect a portion of the interrogation signal 204 and to form their corresponding signals D9-D12. After a predetermined period, each security tag ST then restores its original impedance in preparation for the next interrogation signal. Should a security tag that has already responded to the interrogation signal 204 restore its original impedance prematurely, e.g., while the interrogation signal 204 is still interrogating other security tags ST in other columns, that particular security tag ST will recognize the particular interrogation signal 204 and alter its impedance to become substantially transparent again.

The RFID chip 22 comprises, among other things, non-volatile memory such that when power is removed (e.g., the RFID reader 202 is silent), the RFID chip 22 forms a state machine that knows its prior response history.

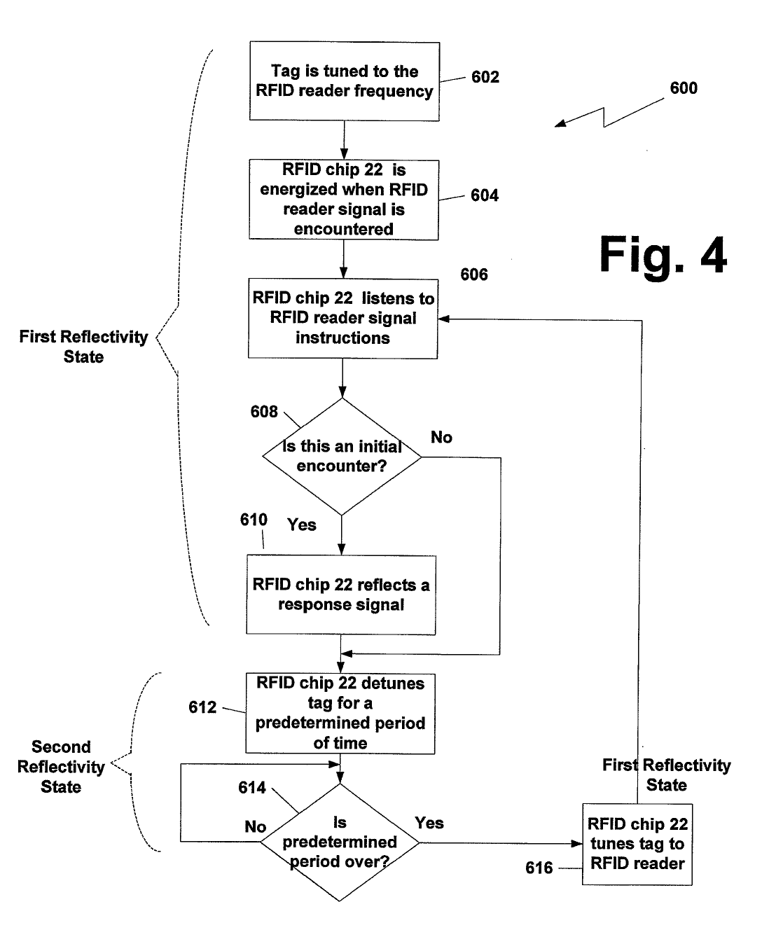

FIG. 4 is an exemplary flow diagram of the operation of the tag tuning/detuning process 600. The tag's initial state 602 is in its tuned condition so that when the original RFID reader signal 204 impinges on the tag 20-420, the tag is energized (step 604) and then the RFID chip 22 can then listen to the instructions from the RFID reader 202 (step 606). At step 608, the RFID chip 22 then determines whether it has already responded to the instructions from the RFID reader 202 or not. If this is a first time encounter with respect to these instructions, the RFID chip 22 moves to step 610 and reflects the response signal 426. The RFID chip 22 then moves to the second reflectivity state by detuning the tag for a predetermined period of time at step 612. The RFID chip 22 then utilizes its remaining power to monitor the time elapsed during the predetermined period in step 614. If the period has not elapsed, the RFID chip 22 continues to monitor; if the period has expired, in step 616, the RFID chip 22 uses whatever remaining power there is to retune the tag into the first reflectivity state. This re-energizes the tag so that it can move to step 606 and listen to the RFID reader instructions. If the RFID chip 22 determines that this is the previous set of instructions that it has already responded to, then the RFID chip 22 moves to step 612 and detunes again; if, on the other hand, these are new RFID reader instructions, the RFID chip 22 moves to step 610 and reflects a response signal 426 and then moves to step 612, as discussed previously.

It should be noted that process 600 is by way of example only and that other processes can be used. In any of the processes, the completion of the second reflectivity state must always place the security tag 20-420 into the first reflectivity state so that the security tag can be re-energized. Thus, if step 612 involves detuning the tag until all power runs out, the default mechanism in the RFID chip 22 is to power off such that the tag 20-420 is placed into the tuned or first reflectivity state.

It should be also noted that the predetermined period of time can be defined in any number of ways. If the physical layout of items having the tags associated therewith are known, the predetermine period can be the time it takes the reader to complete communications with all of the tags in the reader field.

For wide adaptability of the security tag 20-420, it may be desirable to have the tags 20-420 detune to a frequency that RFID readers in other jurisdictions are tuned (e.g., 860 MHz). That way, the RFID chip 22 in the tags 20-420 can be programmed to simply reverse the tune/detune process from the other jurisdiction.

While the invention has been described in detail and with reference to specific examples thereof, it will be apparent to one skilled in the art that various changes and modifications can be made therein without departing from the spirit and scope thereof.

What is claimed is:

1. A radio frequency identification (RFID) system comprising:
a reader for emitting an interrogation signal and for receiving response signals based thereon; and
a first tag for emitting a respective response signal based upon receipt of said interrogation signal and defining a first reflectivity that casts a shadow on at least a second tag, said first tag comprising circuitry that alters said first reflectivity state to a second reflectivity state that makes said first tag substantially transparent to said interrogation signal such that said interrogation signal can illuminate said second tag without physically moving either said first or second tag.

2. The system of claim 1 wherein said second reflectivity is temporary.

3. The system of claim 1 wherein said second tag comprises circuitry that alters a first reflectivity of said second tag, which casts a shadow on a third or more tags, to a second reflectivity that makes said second tag substantially transparent to said interrogation signal such that said interrogation signal can illuminate a third or more tags without physically moving either said second or third or more tags.

4. The system of claim 2 wherein said second reflectivity of said second tag is temporary.

5. The system of claim 1 wherein each of said first, second, or more tags comprises:
a single open loop; and
an RFID chip, coupled across said opening of said single open loop, and wherein said RFID chip effects the alteration between said first and second reflectivities.

6. The system of claim 5 wherein said RFID chip comprises a digital timing circuit for controlling the alteration between said first and second reflectivities.

7. The system of claim 5 wherein said RFID chip comprises an analog timing circuit for controlling the alteration between said first and second reflectivities.

8. The system of claim 5 wherein said analog time circuit comprises a floating gate MOSFET switch.

9. The system of claim 5 wherein said RFID chip comprises a variable impedance device.

10. The system of claim 5 wherein said RFID chip comprises a signal processing unit that comprises digital memory and program code stored therein.

11. The system of claim 5 wherein said RFID chip comprises a high Q value.

12. The system of claim 5 wherein said RFID chip comprises variable capacitors.

13. The system of claim 1 wherein each of said first, second, or more tags comprises:
two dipole antenna elements; and
an RFID chip, coupled between said two dipole antenna elements, that effects the alteration between said first and second reflectivities.

14. The system of claim 13 wherein said RFID chip includes a variable impedance device for effecting the alteration between said first and second reflectivities.

15. The system of claim 14 wherein said RFID chip includes a pair of switches for controlling the variable impedance device.

16. The system of claim 1 wherein each of said first, second, or more tags comprises:
a loop antenna; and
an RFID chip, coupled to said loop antenna, that effects the alteration between said first and second reflectivities.

17. The system of claim 16 further comprising a capacitive element that is switched in or out by said RFID chip for effecting the alteration between said first and second reflectivities.

18. The system of claim 16 further comprising a switch element that open circuits or close circuits said loop antenna for effecting the alteration between said first and second reflectivities.

19. The system of claim 2 wherein a period during which the tag is transparent to said interrogation signal is defined by a time said reader takes to complete communications with one or more other tags in a field of said reader.

20. A method of interrogating a group of RFID tags comprising:
(a) emitting a first reader signal from a reader toward the group of RFID tags;
(b) energizing a first tag having an RFID chip and tuned to a reader frequency for defining a first reflectivity state of said first tag;
(c) listening to instructions within said first reader signal by said first tag to determine if said first reader signal is an initial encounter or a repeat encounter;
(d) generating a reflected response signal from said first RFID tag if said first reader signal is an initial encounter;
(e) temporarily altering the reflectivity of said first RFID tag to a second reflectivity state to render said first RFID tag substantially transparent to said first reader signal, thereby permitting a second tag located in a shadow of said first RFID tag to receive said first reader signal, said second tag being in a first reflectivity state for receiving said first reader signal; and
(f) said second tag comprising an RFID chip and generating its own reflected signal from said first reader signal; and
(g) said first tag restoring itself to said first reflectivity state after temporarily altering said reflectivity.

21. The method of claim 20 further comprising the steps of:
(h) returning to step (c) following step (g); and
(i) temporarily altering said reflectivity of said first tag again to said second reflectivity state if said tag determines a repeat encounter in step (c).

22. The method of claim 20 wherein said step of temporarily altering the reflectivity comprises using a predetermined period of time that is monitored by said RFID chip.

23. The method of claim 22 wherein said first RFID tag restores itself to said first reflectivity state just before total power is lost which occurs at the end of said predetermined period.

24. The method of claim 20 further comprising the step of said second tag temporarily altering the reflectivity of said second RFID tag to a second reflectivity state to render said second RFID tag substantially transparent to said first reader signal, thereby permitting a third or more tags located in a shadow of said second RFID tag to receive said first reader signal.

25. The method of claim 24 further comprising the steps of said second tag
(j) listening to instructions within said first reader signal by said second tag to determine if said first reader signal is an initial encounter or a repeat encounter; and
(k) returning to its second reflectivity state if said second tag determines a repeat encounter.

26. The method of claim 25 wherein said step of temporarily altering the reflectivity of said second tag comprises using a predetermined period of time that is monitored by said RFID chip in said second tag.

27. The method of claim 26 wherein said second RFID tag restores itself to said first reflectivity state just before total power is lost which occurs at the end of said predetermined period.

28. The method of claim 20 wherein said step of temporarily altering the reflectivity of said first RFID tag to a second reflectivity state comprises introducing a variable impedance into said first tag.

29. The method of claim 20 wherein said step of temporarily altering the reflectivity of said first RFID tag to a second reflectivity state comprises opening a loop of said first RFID tag.

30. The method of claim 20 wherein said RFID chip comprises variable capacitors and wherein said step of temporarily altering the reflectivity of said RFID tag comprises utilizing said variable capacitors.

31. A radio frequency identification (RFID) tag comprising:
an antenna; and
an RFID chip coupled to said antenna, said RFID chip comprising tag reflectivity circuitry, said tag reflectivity circuitry permitting said tag to become temporarily detuned from a first RFID reader signal emitted by an RFID reader once said RFID security tag has responded to said first RFID reader signal and then to re-tune said RFID security tag to said RFID reader.

32. The RFID tag of claim 31 wherein said tag reflectivity circuitry comprises a digital timing circuit for effecting said temporarily detuned tag from a first reflectivity state wherein said tag is tuned to said RFID reader to a second reflectivity state wherein said tag is detuned from said RFID reader.

33. The RFID tag of claim 31 wherein said tag reflectivity circuitry comprises an analog timing circuit for effecting said temporarily detuned tag from a first reflectivity state wherein said tag is tuned to said RFID reader to a second reflectivity state wherein said tag is detuned from said RFID reader.

34. The RFID tag of claim 31 wherein said antenna comprises a loop and wherein said tag reflectivity circuitry comprises a capacitive element that is switched in or out by said RFID chip for effecting the alteration between said first and second reflectivity states.

35. The RFID tag of claim 29 wherein said antenna comprises a loop and wherein said tag reflectivity circuitry comprises a switch that open circuits or close circuits said antenna by said RFID chip for effecting the alteration between said first and second reflectivity states.

36. The RFID tag of claim 31 wherein said RFID chip comprises variable capacitors for tuning and detuning said tag.

37. A method of automatically altering the reflectivity of an RFID tag comprising:
(a) providing an antenna coupled to an RFID chip to form the RFID tag and wherein said RFID tag is initially tuned to an RFID reader frequency, defining a first reflectivity state;
(b) energizing said RFID tag upon receipt of an RFID reader signal having a frequency to which said RFID tag is tuned;
(c) listening, by said RFID chip, to instructions within said RFID reader signal by to determine if said reader signal is an initial encounter or a repeat encounter;
(d) generating a reflected response signal from said RFID tag if said first reader signal is an initial encounter;
(e) temporarily altering the reflectivity of said RFID tag to a second reflectivity state to render said RFID tag substantially transparent to said RFID reader signal; and
(f) restoring said RFID tag to said first reflectivity state.

38. The method of claim 37 further comprising the steps of:
(g) returning to step (c) following step (e); and
(h) temporarily altering said reflectivity of said RFID tag again to said second reflectivity state if said RFID tag determines a repeat encounter in step (c).

39. The method of claim 38 wherein said step of temporarily altering said reflectivity comprises using a predetermined period of time that is monitored by said RFID chip.

40. The method of claim 38 wherein first RFID tag restores itself to said first reflectivity state just before total power is lost which occurs at the end of said predetermined period.

41. The method of claim 37 wherein said RFID chip comprises variable capacitors and wherein said step of temporarily altering the reflectivity of said RFID tag comprises utilizing said variable capacitors.
